(19) United States
(12) Patent Application Publication
(10) Pub. No.: US 2024/0120703 A1
(43) Pub. Date: Apr. 11, 2024

(54) LIGHT AMPLIFICATION DEVICE AND LIGHT AMPLIFICATION METHOD

(71) Applicant: NEC Corporation, Minato-ku, Tokyo (JP)

(72) Inventor: Hitoshi TAKESHITA, Tokyo (JP)

(73) Assignee: NEC Corporation, Minato-ku, Tokyo (JP)

(21) Appl. No.: 18/275,989

(22) PCT Filed: Feb. 4, 2022
(86) PCT No.: PCT/JP2022/004416

§ 371 Date: Aug. 4, 2023

(30) Foreign Application Priority Data
Feb. 26, 2021 (JP) 2021-030665

(51) Int. Cl. H01S 3/094; H01S 3/067; H01S 3/23

(52) U.S. Cl. CPC H01S 3/094015; H01S 3/06758; H01S 3/2383

(57) ABSTRACT

Because a light amplification device using a multicore optical fiber provides low utilization efficiency of excitation light according to a cladding excitation system, the present disclosure provides a light amplification device including: a first optical waveguide including a first light amplification medium; a second optical waveguide including a second light amplification medium; a first excitation light introducing circuit for introducing first excitation light for exciting the first light amplification medium into the first optical waveguide; and a first residual excitation light introducing circuit for introducing first residual excitation light which is output from the first optical waveguide and has a wavelength component of the first excitation light, into the second optical waveguide.

### TECHNICAL FIELD

The present invention relates to a light amplification device and a light amplification method, in particular, to a light amplification device and a light amplification method that use a multicore optical fiber.

### BACKGROUND ART

Expansion of communication capacity in a core network is demanded due to a rapid growth of mobile traffic and video services, and the like. This demand for capacity expansion is likely to continue in the future. Communication capacity expansion has so far been achieved by using a time-multiplexing technique and a wavelength-multiplexing technique. The time-multiplexing technique and the wavelength-multiplexing technique have been applied to an optical communication system using a single-core optical fiber.

When a single-core optical fiber is used, the number of multiplexes that can be applied to optical signals to be transmitted through a single-core, that is, a single optical fiber core, is limited, and this limit is being reached in recent years. The limit on the number of multiplexes depends on a wavelength bandwidth that can be used in optical fiber communication and input optical intensity tolerance of the single-core optical fiber.

In such a situation, in order to further expand communication capacity, a spatial-multiplexing technique being a multiplexing technique of a different dimension from the conventional multiplexing techniques is developed. The spatial-multiplexing technique includes a multicore technique of increasing the number of cores per optical fiber, and a multi-mode technique of increasing the number of propagation modes. The number of cores and the number of modes being used in conventional optical fiber communication are both one. Therefore, it is possible to significantly expand communication capacity by increasing the number of cores and the number of modes.

However, when the number of optical fiber cores and the number of modes are increased, it is not possible to use an optical transceiver and an optical amplifier that are currently in wide use, without modification. This is because the optical transceiver and the optical amplifier that are currently in wide use are developed for a single-core optical fiber and do not have compatibility with a multicore optical fiber and a multi-mode optical fiber. Therefore, a technique for achieving an optical transceiver and an optical amplifier that are suitable for a multicore optical fiber and a multi-mode optical fiber has been proposed.

There are two types of light amplification methods suitable for a multicore optical fiber: a core excitation method and a cladding excitation method. In the core excitation method, intensity of an optical signal optically transmitted through each core is separately amplified by using a separate excitation light source for each core. In the cladding excitation method, intensity of an optical signal optically transmitted through each core is collectively amplified by using a shared excitation light source.

In order to efficiently amplify optical intensity of an optical signal transmitted through a multicore optical fiber, the cladding excitation method is desirable in which intensity of an optical signal optically transmitted through each core is collectively amplified by using a shared excitation light source. In the cladding excitation method, a configuration of an optical amplifier using a conventional single-core excitation method can be used, without modification in principle, as a configuration of an optical amplifier using the cladding excitation method.

One example of such an optical amplifier using the cladding excitation method is described in PTL 1. A related optical amplifier 10 described in PTL 1 includes seven optical isolators 1, an optical fiber fan-in 2, a semiconductor laser 3, a first optical coupler 4, a multicore EDF 5, a second optical coupler 6, a pump stripper 7, an optical fiber fan-out 8, and seven optical isolators 9. Herein, the first optical coupler 4 includes a main optical fiber 4a, an optical fiber 4b for excitation light input/output, an optical fiber 4c for excitation light supply, and a protection unit 4d. The second optical coupler 6 includes a main optical fiber 6a, an optical fiber 6b for excitation light input/output, and a protection unit 6d.

According to the related optical amplifier 10, at least a part of excitation light that does not contribute to optical excitation in the multicore EDF 5, of the excitation light being output from the semiconductor laser 3 and supplied to the multicore EDF 5 via the first optical coupler 4, is recovered by the second optical coupler 6. The recovered excitation light is input to the first optical coupler 4 through the optical fiber 6b for excitation light input/output and the optical fiber 4b for excitation light input/output, is regenerated as excitation light, and is again supplied to the multicore EDF 5. Thereby, excitation efficiency in the related optical amplifier 10 can be improved.

### CITATION LIST

### Patent Literature

PTL 1: International Patent Publication No. WO2019/117314

### SUMMARY OF INVENTION

### Technical Problem

In a light amplification device using the cladding excitation method, such as the related optical amplifier described above, absorption efficiency of an excitation light component in an optical amplification medium is about one-tenth of absorption efficiency when the core excitation method is used. Therefore, utilization efficiency of excitation light is extremely low in the light amplification device using the cladding excitation method compared to utilization efficiency of excitation light when the core excitation method is used.

Thus, there is a problem that, when the cladding excitation method is used, utilization efficiency of excitation light is low in a light amplification device using a multicore optical fiber.

An object of the present invention is to provide a light amplification device and a light amplification method that solve the above-described problem being a problem that utilization efficiency of excitation light is low in a light amplification device using a multicore optical fiber when the cladding method is used.

### Solution to Problem

A light amplification device according to the present invention includes: a first optical waveguide means including a first light amplification medium; a second optical waveguide means including a second light amplification medium; a first excitation light introducing means for introducing first excitation light that excites the first light amplification medium, into the first optical waveguide means; and a first residual excitation light introducing means for introducing first residual excitation light that is output from the first optical waveguide means and contains a wavelength component of the first excitation light, into the second optical waveguide means.

A light amplification method according to the present invention includes: introducing first signal light into a first optical waveguide including a first light amplification medium; introducing second signal light into a second optical waveguide including a second light amplification medium; introducing first excitation light that excites the first light amplification medium, into the first optical waveguide; and introducing first residual excitation light that is output from the first optical waveguide and contains a wavelength component of the first excitation light, into the second optical waveguide.

### Advantageous Effects of Invention

According to the light amplification device and the light amplification method of the present invention, utilization efficiency of excitation light can be increased even when a light amplification device including a multicore optical fiber is used in a cladding excitation method.

### BRIEF DESCRIPTION OF DRAWINGS

FIG. 1 is a block diagram illustrating a configuration of a light amplification device according to a first example embodiment of the present invention.

FIG. 2 is a block diagram illustrating another configuration of the light amplification device according to the first example embodiment of the present invention.

FIG. 3 is a block diagram illustrating a configuration of a light amplification device according to a second example embodiment of the present invention.

FIG. 4 is a block diagram illustrating another configuration of the light amplification device according to the second example embodiment of the present invention.

FIG. 5 is a block diagram illustrating a configuration of a light amplification device according to the third example embodiment of the present invention.

FIG. 6 is a block diagram illustrating a configuration of a light amplification device according to a fourth example embodiment of the present invention.

### EXAMPLE EMBODIMENT

In the following, example embodiments of the present invention are described with reference to the drawings.

### First Example Embodiment

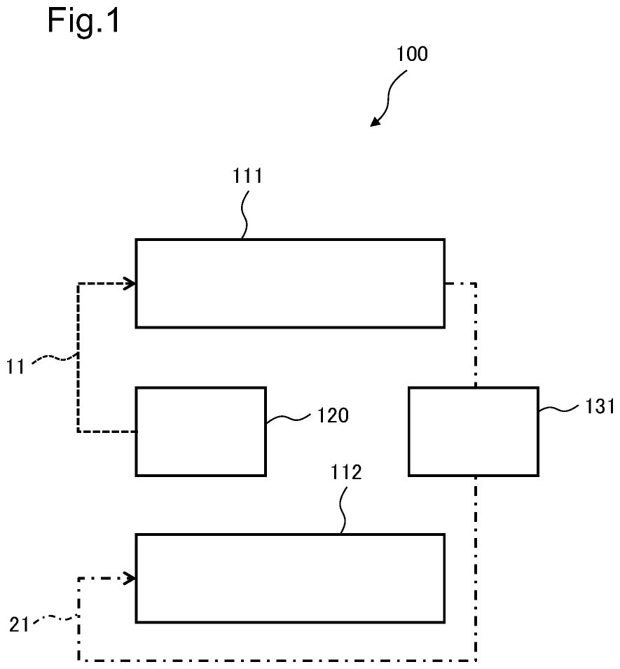

FIG. 1 is a block diagram illustrating a configuration of a light amplification device 100 according to a first example embodiment of the present invention. The light amplification device 100 includes a first optical waveguide (first optical waveguide means) 111, a second optical waveguide (second optical waveguide means) 112, a first excitation light introducing unit (first excitation light introducing means) 120, and a first residual excitation light introducing unit (first residual excitation light introducing means) 131.

The first optical waveguide 111 includes a first light amplification medium. The second optical waveguide 112 includes a second light amplification medium.

The first excitation light introducing unit 120 introduces first excitation light 11, which excites the first light amplification medium, into the first optical waveguide 111. Then, the first residual excitation light introducing unit 131 introduces first residual excitation light 21, which is output from the first optical waveguide 111 and contains a wavelength component of the first excitation light, into the second optical waveguide 112.

By employing such a configuration, in the light amplification device 100 according to the present example embodiment, excitation light that is output without being absorbed in the first light amplification medium can be introduced into the second optical waveguide 112 as the first residual excitation light 21 and can be used for exciting the second light amplification medium. Therefore, according to the light amplification device 100 according to the present example embodiment, utilization efficiency of excitation light can be increased.

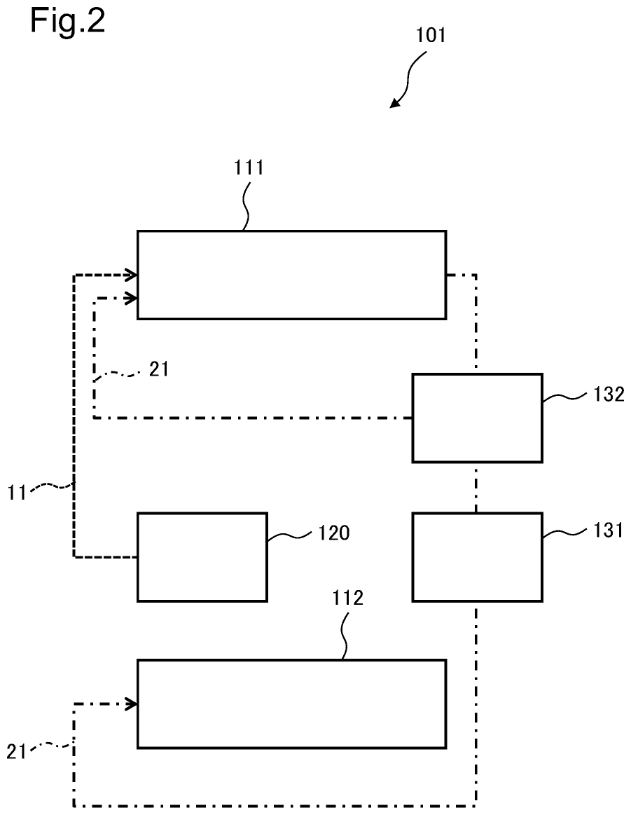

Another configuration of the light amplification device according to the first example embodiment of the present invention is described in FIG. 2. The light amplification device 101 illustrated in FIG. 2 is configured in such a way as to further include, in addition to the configuration of the light amplification device 100 illustrated in FIG. 1, a second residual excitation light introducing unit (second residual excitation light introducing means) 132. Herein, the second residual excitation light introducing unit 132 introduces the first residual excitation light 21 into the first optical waveguide 111.

By employing such a configuration, in the light amplification device 101, excitation light that is output without being absorbed in the first light amplification medium can be used for exciting the second light amplification medium and can also be reused for exciting the first light amplification medium. Therefore, utilization efficiency of excitation light can be further increased.

Herein, both the first light amplification medium and the second light amplification medium can be constituted of a plurality of cores doped with a rare earth ion. An erbium ion can typically be used as the rare earth ion. Further, both the first optical waveguide 111 and the second optical waveguide 112 can be configured in such a way as to include a multicore optical fiber including plurality of optical transmission paths constituted of the above-described plurality of cores and a double-cladding structure. In this case, the first excitation light introducing unit 120 can be configured in such a way as to introduce the first excitation light 11 into the first optical waveguide 111 with the cladding excitation method.

Next a light amplification method according to the present example embodiment is described.

In the light amplification method according to the present example embodiment, first, first signal light is introduced into a first optical waveguide including a first light amplification medium, and second signal light is introduced into a second optical waveguide including a second light amplification medium. Then, first excitation light, which excites the first light amplification medium, is introduced into the first optical waveguide, and first residual excitation light, which is output from the first optical waveguide and contains a wavelength component of the first excitation light, is introduced into the second optical waveguide. The first residual excitation light may further be introduced into the first optical waveguide.

Thus, in the light amplification method according to the present example embodiment, excitation light that is output without being absorbed in the first light amplification medium can be introduced into the second optical waveguide as the first residual excitation light and can be used for exciting the second light amplification medium. Therefore, according to the light amplification method according to the present example embodiment, utilization efficiency of excitation light can be increased.

As described above, according to the light amplification devices 100 and 101 and the light amplification method of the present example embodiment, utilization efficiency of excitation light can be increased even when a light amplification device including a multicore optical fiber is used in the cladding excitation method.

### Second Example Embodiment

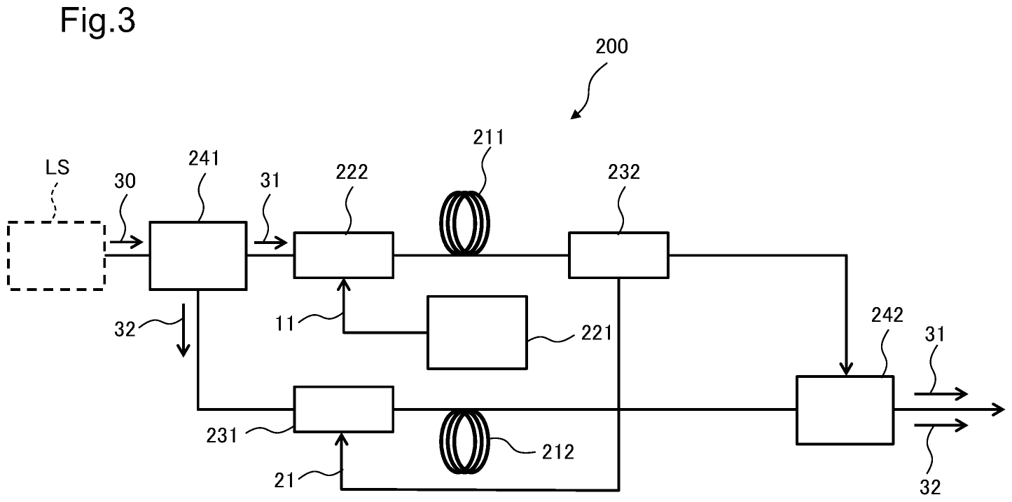

Next, a second example embodiment of the present invention is described. A configuration of a light amplification device 200 according to the present example embodiment is illustrated in FIG. 3.

The light amplification device 200 is configured in such a way as to include a first multicore erbium-doped fiber (MC-EDF) 211 corresponding to a first optical waveguide means, and a second multicore erbium-doped fiber 212 corresponding to a second optical waveguide means. Herein, both the first multicore erbium-doped fiber 211 and the second multicore erbium-doped fiber 212 are multicore optical fibers having a plurality of cores doped with an erbium ion, which is a rare earth ion, and a double-cladding structure.

The light amplification device 200 includes a first excitation light generation unit (first excitation light generation means) 221 and a first optical coupling unit (first optical coupling means) 222. The first excitation light generation unit 221 is typically a semiconductor laser and generates first excitation light 11. The first optical coupling unit 222 couples the first excitation light 11 with the first multicore erbium-doped fiber 211 corresponding to the first optical waveguide means. Herein, the first excitation light generation unit 221 and the first optical coupling unit 222 constitutes a first excitation light introducing means.

The light amplification device 200 further includes a first residual excitation light coupling unit (first residual excitation light coupling means) 231 and a first residual excitation light separation unit (first residual excitation light separation means) 232. The first residual excitation light coupling unit 231 couples first residual excitation light 21 with the second multicore erbium-doped fiber 212. Herein, the first residual excitation light 21 is output from the first multicore erbium-doped fiber 211 and has a wavelength component of the first excitation light. The first residual excitation light separation unit 232 separates the first residual excitation light 21 from first signal light 31 output from the first multicore erbium-doped fiber 211. Note that, the first residual excitation light coupling unit 231 and the first residual excitation light separation unit 232 constitutes a first residual excitation light introducing means.

Thus, in the light amplification device 200 according to the present example embodiment, excitation light that is output without being absorbed in a core of the first multicore erbium-doped fiber 211 is introduced into the second multicore erbium-doped fiber 212 as the first residual excitation light 21. Thereby, the first residual excitation light 21 can be used for exciting a core of the second multicore erbium-doped fiber 212 doped with an erbium ion. Therefore, according to the light amplification device 200 according to the present example embodiment, utilization efficiency of excitation light can be increased.

The light amplification device 200 is configured in such a way as to further include a signal light separation unit (signal light separation means) 241 and a signal light multiplexing unit (signal light multiplexing means) 242. The signal light separation unit 241 separates the signal light 30 into a first signal light 31 to be introduced into the first multicore erbium-doped fiber 211 and a second signal light 32 to be introduced to the second multicore erbium-doped fiber 212. The signal light 30 is supplied, for example, from a light source LS. The signal light multiplexing unit 242 multiplexes the first signal light output from the first multicore erbium-doped fiber 211 and the second signal light output from the second multicore erbium-doped fiber 212.

Herein, for example, the first signal light 31 can belong to a C-band (conventional-band: 1530 nm to 1565 nm) and the second signal light 32 can belong to a L-band (long-wavelength-band: 1565 nm to 1625 nm), among wavelength bands used in optical fiber communication. In this case, the first multicore erbium-doped fiber (first optical waveguide means) 211 can be configured in such a way as to have gain in the C-band (first wavelength band). Further, the second multicore erbium-doped fiber (second optical waveguide means) 212 can be configured in such a way as to have gain in the L-band (second wavelength band), which is different from the C-band (first wavelength band). Specifically, for example, by making the first multicore erbium-doped fiber 211 about eight meters (m) long and making the second multicore erbium-doped fiber 212 about 55 meters (m) long, each of the above-described gain bands can be achieved.

When such a configuration is employed, an excitation laser is usually required for each wavelength band. However, according to the light amplification device 200 according to the present example embodiment, multiband optical amplification using a multicore optical fiber becomes possible by using only one excitation laser (first excitation light generation unit 221). As a result, a light amplification device can be downsized.

As described above, according to the light amplification device 200 of the present example embodiment, utilization efficiency of excitation light excitation light (hereinafter, referred to as “excitation light utilization efficiency”) can be increased. This advantageous effect is described in detail. Herein, a case in which the first multicore erbium-doped fiber 211 and the second multicore erbium-doped fiber 212 are excited by using one excitation laser is described as an example.

Power of excitation light output from the excitation laser is assumed to be 100 (an arbitrary unit). In a usual method, the excitation light is divided into two, and each of the excitation lights of which optical power is 50 is introduced to the first multicore erbium-doped fiber 211 and the second multicore erbium-doped fiber 212. Since excitation light utilization efficiency in a multicore erbium-doped fiber using the cladding excitation method is approximately 20%, in this case, excitation light of which optical power is 10, which is 20% of the excitation light of which optical power is 50 is used for exciting each core. Therefore, excitation light utilization efficiency in total is 20(=10+10)/100.

Meanwhile, in the light amplification device 200 according to the present example embodiment, excitation light of which optical power is 100 is introduced into the first multicore erbium-doped fiber 211. Then, excitation light of which optical power is 20, which is 20% of the excitation light, is used for core excitation, and the remaining 80% is output as the first residual excitation light 21 from the first multicore erbium-doped fiber 211 and introduced into the second multicore erbium-doped fiber 212. In the second multicore erbium-doped fiber 212, residual excitation light of which optical power is 16, which is 20% of the first residual excitation light 21 of which optical power is 80, is used for exciting a core of the second multicore erbium-doped fiber 212. Therefore, of the optical power of which optical power is 100, excitation light of which optical power is 36(=20+16) in total is used for core excitation, and excitation light utilization efficiency becomes 36/100. Thus, according to the light amplification device 200 of the present example embodiment, excitation light utilization efficiency that is 1.8 times higher than the excitation light utilization efficiency (20/100) based on the usual method can be achieved.

Further, according to the light amplification device 200 of the present example embodiment, power saving can also be achieved. Specifically, for example, it is assumed that 75 watts (W) of excitation light is required for exciting the first multicore erbium-doped fiber 211, and 25 watts (W) of excitation light is required for exciting the second multicore erbium-doped fiber 212. This is because excitation light utilization efficiency of a multicore erbium-doped fiber used in the L-band is generally higher than excitation light utilization efficiency of a multicore erbium-doped fiber used in the C-band.

In this case, a total of 100 watts (75 W+25 W) of excitation optical power is required, since an excitation laser is used for each wavelength band in the usual method.

Meanwhile, in the light amplification device 200 according to the present example embodiment, the first excitation light generation unit 221 generates the first excitation light 11 of 75 watts (W) and the core of the first multicore erbium-doped fiber 211 is excited thereby. Then, approximately 80% of the first excitation light 11 is output as residual excitation light without being absorbed in the core of the first multicore erbium-doped fiber 211. Of this residual excitation light (for example, 60 watts), 25 watts (W) of the first residual excitation light 21 can be used for exciting the core of the second multicore erbium-doped fiber 212.

Therefore, while the usual method requires 100 watts (W) of excitation optical power, according to the light amplification device 200 of the present example embodiment, multiband optical amplification can be achieved with 75 watts (W) of excitation optical power, thus power consumption can be reduced by 25%.

In the above-described example embodiment, a configuration is employed in which the signal light 30 is separated into the signal light 31 and the signal light 32, the signal light 31 is introduced into the first multicore erbium-doped fiber 211, and the signal light 32 is introduced into the second multicore erbium-doped fiber 212. However, the configuration is not limited thereto and the first multicore erbium-doped fiber 211 and the second multicore erbium-doped fiber 212 may be configured to be tandemly connected in series with respect to signal light. The signal light is introduced into the first multicore erbium-doped fiber 211, and the signal light after being amplified by the first multicore erbium-doped fiber 211 is introduced into the second multicore erbium-doped fiber 212. In this case, the first multicore erbium-doped fiber 211 and the second multicore erbium-doped fiber 212 can be configured in such a way as to have gain in the same wavelength band. Note that, when such a configuration is employed, it is desirable that a wavelength filter for removing amplified spontaneous emission (ASE) is inserted between the first multicore erbium-doped fiber 211 and the second multicore erbium-doped fiber 212.

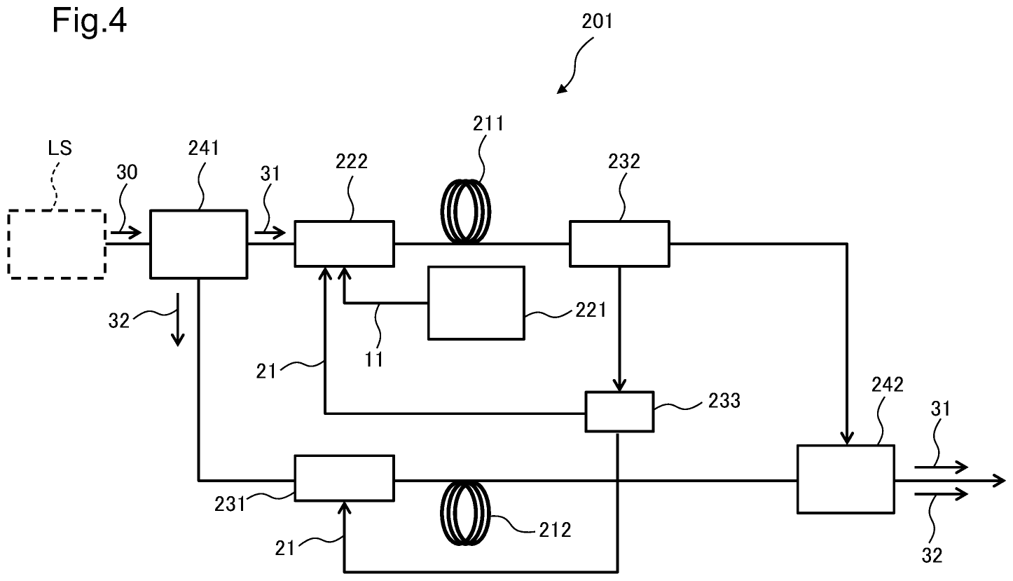

Another configuration of the light amplification device according to the present example embodiment is illustrated in FIG. 4. A light amplification device 201 illustrated in FIG. 4 is configured in such a way as to further include, in addition to the configuration of the light amplification device 200 illustrated in FIG. 3, a residual excitation light splitting unit 233. The residual excitation light splitting unit 233 splits the first residual excitation light 21 and supplies the first residual excitation light 21 to each of the first optical coupling unit 222 and the first residual excitation light coupling unit 231. An optical coupler can typically be used as the residual excitation light splitting unit 233. Herein, the first optical coupling unit 222, the first residual excitation light separation unit 232, and the residual excitation light splitting unit 233 constitutes a second residual excitation light introducing means.

By employing such a configuration, in the light amplification device 201, excitation light that is output without being absorbed in the first multicore erbium-doped fiber 211 can also be reused for exciting the first multicore erbium-doped fiber 211. Therefore, the excitation light utilization efficiency can be further increased.

Further, according to the light amplification device 201 according to the present example embodiment, further power saving can be achieved. This advantageous effect is described in detail, based on the example described by using FIG. 3.

Fifteen watts (W), which is 20% of the first excitation light 11 of 75 watts (W) for exciting the first multicore erbium-doped fiber 211, is absorbed in the core of the first multicore erbium-doped fiber 211. Then, the remaining 60 watts (W) is output as the first residual excitation light 21. Twenty-five watts (W) of the first residual excitation light 21 is used for exciting the second multicore erbium-doped fiber 212. The remaining 35 watts (W) of the residual excitation light can be reused as the first residual excitation light 21 for exciting the first multicore erbium-doped fiber 211. Therefore, power of the first excitation light 11 generated by the first excitation light generation unit 221 can be reduced from the original 75 watts (W). Consequently, power consumption can be further reduced.

As described above, according to the light amplification devices 200 and 201 of the present example embodiment, even when a light amplification device including a multicore optical fiber is used in the cladding excitation method, utilization efficiency of excitation light can be increased. Further, according to the light amplification devices 200 and 201 of the present example embodiment, it is possible to reduce a size and power consumption of the light amplification device.

### Third Example Embodiment

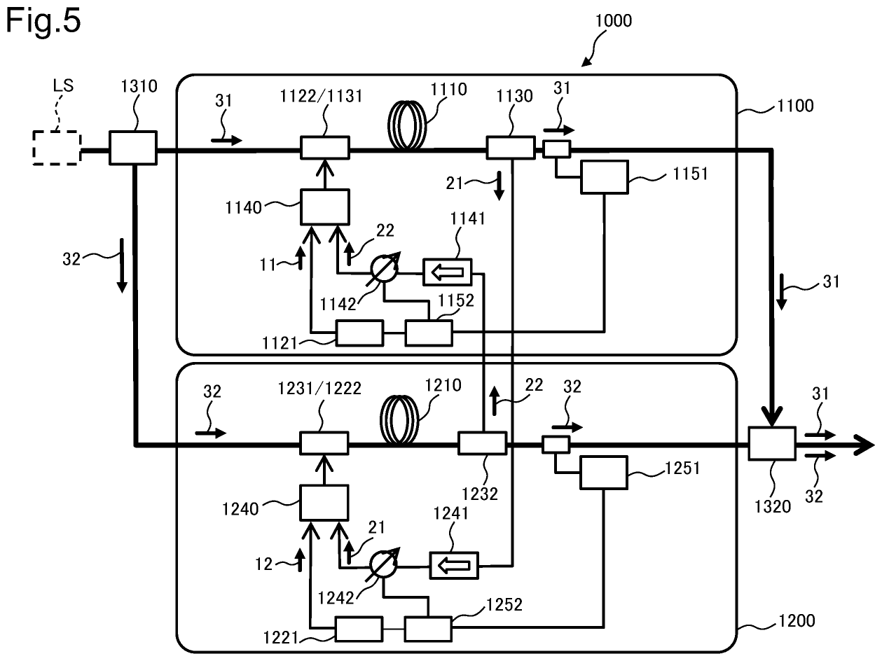

Next, a third example embodiment of the present invention is described. A configuration of a light amplification device 1000 according to the present example embodiment is illustrated in FIG. 5. The light amplification device 1000 according to the present example embodiment includes a first amplification unit 1100, a second amplification unit 1200, a signal light separation unit 1310, and a signal light multiplexing unit 1320. Herein, for example, the first amplification unit 1100 can be used for amplifying signal light in a C-band of wavelength bands used in optical fiber communication, and the second amplification unit 1200 can be used for amplifying signal light in an L-band.

The signal light separation unit 1310 separates signal light supplied from a signal light source LS into first signal light 31 to be input to the first amplification unit 1100 and second signal light 32 to be input to the second amplification unit 1200. The signal light multiplexing unit 1320 multiplexes the first signal light output from the first amplification unit 1100 and the second signal light output from the second amplification unit 1200. Herein, the first signal light 31 may belong to the C-band and the second signal light 32 may belong to the L-band.

The first amplification unit 1100 includes a first multicore erbium-doped fiber 1110 as a first optical waveguide means, a first excitation light generation unit (first excitation light generation means) 1121, a first optical coupling unit (first optical coupling means) 1122, and a first residual excitation light separation unit (first residual excitation light separation means) 1130. The first excitation light generation unit 1121 is typically a semiconductor laser and generates first excitation light 11. The first optical coupling unit 1122 couples the first excitation light 11 to the first multicore erbium-doped fiber 1110. Then, the first residual excitation light separation unit 1130 separates the first residual excitation light 21 from the first signal light 31 output from the first multicore erbium-doped fiber 1110. Herein, the first residual excitation light 21 is output from the first multicore erbium-doped fiber 1110 and contains a wavelength component of the first excitation light.

The second amplification unit 1200 includes a second multicore erbium-doped fiber 1210 as a second optical waveguide means, and a first residual excitation light coupling unit (first residual excitation light coupling means) 1231. The first residual excitation light coupling unit 1231 couples the first residual excitation light 21 to the second multicore erbium-doped fiber 1210.

Note that, the first excitation light generation unit 1121 and the first optical coupling unit 1122 constitutes a first excitation light introducing means, and the first residual excitation light separation unit 1130 and the first residual excitation light coupling unit 1231 constitutes a first residual excitation light introducing means.

The configuration described so far is similar to the configuration of the light amplification device 200 according to the second example embodiment. The light amplification device 1000 according to the present example embodiment is configurated in such a way as to further include a second excitation light introducing unit (second excitation light introducing means) and a third residual excitation light introducing unit (third residual excitation light introducing means).

The second excitation light introducing unit introduces second excitation light 12, which excites a plurality of cores (second light amplification medium) doped with erbium ions and included in the second multicore erbium-doped fiber 1210, into the second multicore erbium-doped fiber 1210 (second optical waveguide means). Herein, the second excitation light introducing unit can be configured in such a way as to introduce the second excitation light 12 into the second multicore erbium-doped fiber 1210 by using a cladding excitation method.

Specifically, as illustrated in FIG. 5, the second excitation light introducing unit can be configured in such a way as to include a second excitation light generation unit (second excitation light generation means) 1221 and a second optical coupling unit (second optical coupling means) 1222. Herein, the second excitation light generation unit 1221 is typically a semiconductor laser and generates the second excitation light 12. The second optical coupling unit 1222 couples the second excitation light 12 to the second multicore erbium-doped fiber 1210.

The third residual excitation light introducing unit introduces second residual excitation light 22, which is output from the second multicore erbium-doped fiber 1210 and contains a wavelength component of the second excitation light, into the first multicore erbium-doped fiber 1110. Specifically, as illustrated in FIG. 5, the third residual excitation light introducing unit can be configured in such a way as to include a second residual excitation light coupling unit (second residual excitation light coupling means) 1131 and a second residual excitation light separation unit (second residual excitation light separation means) 1232. Herein, the second residual excitation light coupling unit 1131 couples the second residual excitation light 22 to the first multicore erbium-doped fiber 1110. The second residual excitation light separation unit 1232 separates the second residual excitation light 22 from the second signal light 32 output from the second multicore erbium-doped fiber 1210.

Thus, in the light amplification device 1000 according to the present example embodiment, excitation light that is output without being absorbed in a core of the first multicore erbium-doped fiber 1110 is introduced into the second multicore erbium-doped fiber 1210 as the first residual excitation light 21. Further, the light amplification device 1000 is configured in such a way as to introduce excitation light that is output without being absorbed in a core of the second multicore erbium-doped fiber 2210 into the first multicore erbium-doped fiber 1110 as the second residual excitation light 22. Therefore, according to the light amplification device 1000 according to the present example embodiment, since each of the first excitation light 11 and the second excitation light 12 can be reused, utilization efficiency of excitation light can be increased.

In the light amplification device 1000 according to the present example embodiment, a wavelength of the first excitation light 11 generated by the first excitation light generation unit 1121 can be different from a wavelength of the second excitation light 12 generated by the second excitation light generation unit 1221. Specifically, for example, the wavelength of the first excitation light 11 is 976 nanometers (nm) and the wavelength of the second excitation light 12 is 980 nanometers (nm). In this case, both the first excitation light 11 and the second excitation light 12 can excite each of the multicore erbium-doped fibers having gain in the C-band or the L-band.

Further, the light amplification device 1000 can be configured in such a way as to include a first excitation light multiplexing unit (first excitation light multiplexing means) 1140 and a second excitation light multiplexing unit (second excitation light multiplexing means) 1240, as illustrated in FIG. 5. Herein, the first excitation light multiplexing unit 1140 multiplexes the first excitation light 11 and the second residual excitation light 22. The second excitation light multiplexing unit 1240 multiplexes the second excitation light 12 and the first residual excitation light 21. Specifically, the first excitation light introducing means and the third residual excitation light introducing means can be configured in such a way as to include the first excitation light multiplexing means and the second excitation light introducing means and first residual excitation light introducing means can be configured in such a way as to include the second excitation light multiplexing means.

Specifically, for example, the first excitation light multiplexing unit 1140 wavelength-multiplexes the first excitation light 11 of which wavelength is 976 nanometers (nm) and the second residual excitation light 22 of which wavelength is 980 nanometers (nm). The second excitation light multiplexing unit 1240 wavelength-multiplexes the second excitation light 12 of which wavelength is 980 nanometers (nm) and the first residual excitation light 21 of which wavelength is 976 nanometers (nm).

Thus, by the first excitation light multiplexing unit 1140, a configuration can be achieved in which the first excitation light 11 and the second residual excitation light 22 are wavelength-multiplexed and then coupled to the first multicore erbium-doped fiber 1110. Therefore, it is possible to communize the first optical coupling unit 1122 and the second residual excitation light coupling unit 1131 and to use a single port on an input side. Likewise, by the second excitation light multiplexing unit 1240, a configuration can be achieved in which the second excitation light 12 and the first residual excitation light 21 are wavelength-multiplexed and then coupled to the second multicore erbium-doped fiber 1210. Therefore, it is possible to communize the first residual excitation light coupling unit 1231 and the second optical coupling unit 1222 and to use a single port on an input side.

Herein, at least either the first excitation light multiplexing unit (first excitation light multiplexing means) 1140 or the second excitation light multiplexing unit (second excitation light multiplexing means) 1240 can be a spatial coupling type multiplexing unit (spatial coupling type multiplexing means) including a spatial optical system. By using a spatial coupling type multiplexing unit as the first excitation light multiplexing unit 1140, most of components can be communized with the first optical coupling unit 1122, the second residual excitation light coupling unit 1131, and the first residual excitation light separation unit 1130. Likewise, by using a spatial coupling type multiplexing unit as the second excitation light multiplexing unit 1240, most of components can be communized with the first residual excitation light coupling unit 1231, the second optical coupling unit 1222, and the second residual excitation light separation unit 1232. Consequently, it is possible to reduce a cost of the light amplification device 1000. Note that, a wavelength division multiplexing (WDM) coupler and arrayed waveguide gratings (AWG) may be used as the first excitation light multiplexing unit 1140 and the second excitation light multiplexing unit 1240.

As illustrated in FIG. 5, the light amplification device 1000 may be configured in such a way as to include an optical isolator 1241 and an optical attenuator 1242 in an optical path of the first residual excitation light 21 from the first residual excitation light separation unit 1130 to the second excitation light multiplexing unit 1240. Likewise, the light amplification device 1000 may be configured in such a way as to include an optical isolator 1141 and an optical attenuator 1142 in an optical path of the second residual excitation light 22 from the second residual excitation light separation unit 1232 to the first excitation light multiplexing unit 1140.

Further, as illustrated in FIG. 5, the light amplification device 1000 can be configured in such a way as to further include a first monitoring unit (first monitoring means) 1151 and a first control unit (first control means) 1152. Herein, the first monitoring unit 1151 monitors optical intensity of at least one of the first signal light 31 and the first residual excitation light 21 output from the first multicore erbium-doped fiber (first optical waveguide means) 1110. Then, the first control unit 1152 controls, based on a result of monitoring by the first monitoring unit 1151, at least either the optical attenuator (first optical attenuation means) 1142, which controls optical intensity of the second residual excitation light 22, or the first excitation light generation unit 1121. By employing such a configuration, optical intensity of the first signal light 31 output from the first multicore erbium-doped fiber 1110 can be controlled.

Likewise, the light amplification device 1000 can be configured in such a way as to further include a second monitoring unit (second monitoring means) 1251 and a second control unit (second control means) 1252. Herein, the second monitoring unit 1251 monitors optical intensity of at least one of the second signal light 32 and the second residual excitation light 22 output from the second multicore erbium-doped fiber (second optical waveguide means) 1210. Then, the second control unit 1252 controls, based on a result of monitoring by the second monitoring unit 1251, at least either the optical attenuator (second optical attenuation means) 1242, which controls optical intensity of the first residual excitation light 21, or the second excitation light generation unit 1221. By employing such a configuration, optical intensity of the second signal light 32 output from the second multicore erbium-doped fiber 1210 can be controlled.

Next, a light amplification method according to the present example embodiment is described.

In the light amplification method according to the present example embodiment, first, first signal light is introduced into a first optical waveguide including a first light amplification medium, and second signal light is introduced into a second optical waveguide including a second light amplification medium. Then, first excitation light, which excites the first light amplification medium, is introduced into the first optical waveguide, and first residual excitation light, which is output from the first optical waveguide and contains a wavelength component of the first excitation light, is introduced into the second optical waveguide. Further, the first residual excitation light may also be introduced into the first optical waveguide.

The configuration described so far is similar to the light amplification method according to the first example embodiment. The light amplification method according to the present example embodiment is configured in such a way as to further include introducing second excitation light, which excites the second light amplification medium, into the second optical waveguide, and introducing second residual excitation light, which is output from the second optical waveguide and contains a wavelength component of the second excitation light, into the first optical waveguide.

As described above, according to the light amplification device 1000 and the light amplification method of the present example embodiment, utilization efficiency of excitation light can be increased even when a light amplification device including a multicore optical fiber is used in the cladding excitation method.

### Fourth Example Embodiment

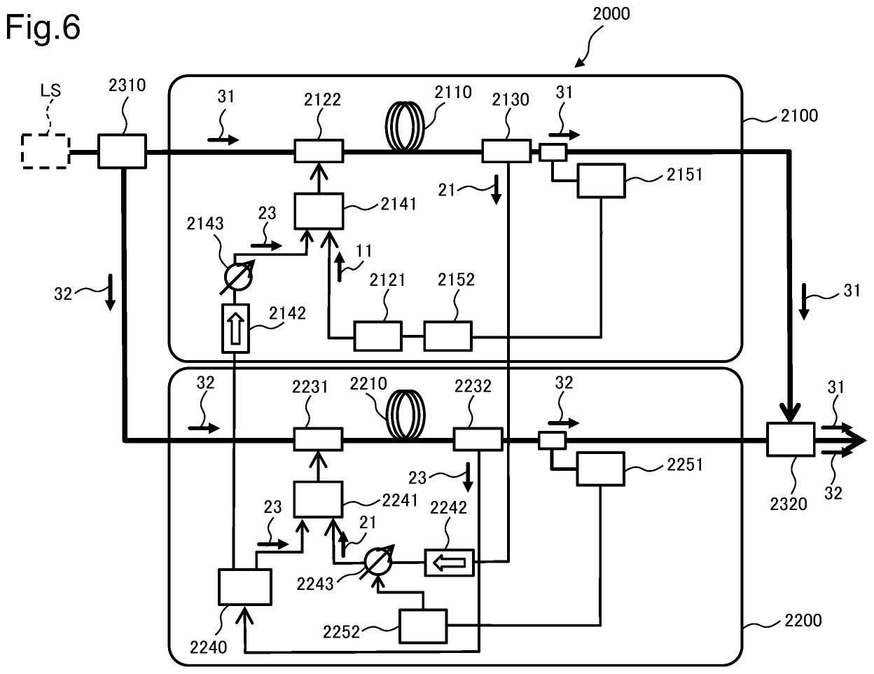

Next, a fourth example embodiment of the present invention is described. A configuration of a light amplification device 2000 according to the present example embodiment is illustrated in FIG. 6. The light amplification device 2000 according to the present example embodiment includes a first amplification unit 2100, a second amplification unit 2200, a signal light separation unit 2310, and a signal light multiplexing unit 2320. Herein, the first amplification unit 2100 can be used for amplifying signal light in a C-band, and the second amplification unit 2200 can be used for amplifying signal light in an L-band.

The signal light separation unit 2310 separates signal light supplied from a signal light source LS into first signal light 31 to be introduced into the first amplification unit 2100 and second signal light 32 to be introduced into the second amplification unit 2200. The signal light multiplexing unit 2320 multiplexes the first signal light output from the first amplification unit 2100 and the second signal light output from the second amplification unit 2200. Herein, the first signal light 31 can, for example, belong to the C-band and the second signal light 32 can belong to the L-band, among wavelength bands used in optical fiber communication.

The first amplification unit 2100 includes a first multicore erbium-doped fiber 2110 as a first optical waveguide means, a first excitation light generation unit (first excitation light generation means) 2121, a first optical coupling unit (first optical coupling means) 2122, and a first residual excitation light separation unit (first residual excitation light separation unit) 2130. The second amplification unit 2200 includes a second multicore erbium-doped fiber 2210 as a second optical waveguide means, and a first residual excitation light coupling unit (first residual excitation light coupling means) 2231.

The configuration described so far is similar to the configuration of the light amplification device 200 according to the second example embodiment. The light amplification device 1000 according to the present example embodiment is configured in such a way as to further include a fourth residual excitation light introducing unit (fourth residual excitation light introducing means) and a fifth residual excitation light introducing unit (fifth residual excitation light introducing means).

The fourth residual excitation light introducing unit introduces third residual excitation light 23, which is output from the second multicore erbium-doped fiber (second optical waveguide means) 2210 and contains a wavelength component of first residual excitation light 21, into the first multicore erbium-doped fiber (first optical waveguide means) 2110. Specifically, for example, as illustrated in FIG. 6, the fourth residual excitation light introducing unit can be configured in such a way as to include a residual excitation light separation unit 2232, which separates third residual excitation light 23 from the second signal light 32, and an optical coupler 2240, which splits the third residual excitation light 23 and supplies one of the split third residual excitation lights 23 into the first amplification unit 2100.

In this case, the first amplification unit 2100 can be configured in such a way as to include an excitation light multiplexing unit 2141, which multiplexes the third residual excitation light 23 and first excitation light 11 output from the first excitation light generation unit 2121, and supply the multiplexed excitation light to the first optical coupling unit 2122. Note that, as illustrated in FIG. 6, the first amplification unit 2100 may be configured in such a way as to include an optical isolator 2142 and an optical attenuator 2143 in an optical path of the third residual excitation light 23 from the optical coupler 2240 to the excitation light multiplexing unit 2141.

The fifth residual excitation light introducing unit introduces the third residual excitation light 23 into the second multicore erbium-doped fiber (second optical waveguide means) 2210. Specifically, for example, as illustrated in FIG. 6, the fifth residual excitation light introducing unit can be configured in such a way as to include a residual excitation light multiplexing unit 2241, which multiplexes the other one of the third residual excitation lights 23 split by the optical coupler 2240 and the first residual excitation light 21 separated by the first residual excitation light separation unit 2130. Further, the fifth residual excitation light introducing unit can be configured in such a way as to supply the residual excitation light after being multiplexed to the first residual excitation light coupling unit 2231. Note that, as illustrated in FIG. 6, the fifth residual excitation light introducing unit may be configured in such a way as to include an optical isolator 2242 and an optical attenuator 2243 in an optical path of the first residual excitation light 21 from the first residual excitation light separation unit 2130 to the residual excitation light multiplexing unit 2241.

For example, a multi-mode combiner, a polarized beam combiner, and the like can be used as the excitation light multiplexing unit 2141 and the residual excitation light multiplexing unit 2241.

Thus, in the light amplification device 2000 according to the present example embodiment, excitation light that is output without being absorbed in a core of the first multicore erbium-doped fiber 2110 is introduced into the second multicore erbium-doped fiber 2210 as the first residual excitation light 21. Further, the light amplification device 2000 is configured in such a way as to introduce the third residual excitation light 23 output without being absorbed in a core of the second multicore erbium-doped fiber 2210 into the first multicore erbium-doped fiber 2110 and to reintroduce the third residual excitation light 23 into the second multicore erbium-doped fiber 2210 as well. Therefore, according to the light amplification device 2000 of the present example embodiment, utilization efficiency of excitation light can be further increased.

Further, as illustrated in FIG. 6, the light amplification device 2000 can be configured in such a way as to further include a first monitoring unit 2151 and a first control unit 2152. Herein, the first monitoring unit 2151 monitors optical intensity of at least one of the first signal light 31 and first residual excitation light 21 output from the first multicore erbium-doped fiber 2110. Then, the first control unit 2152 controls the first excitation light generation unit 2121, based on a result of monitoring by the first monitoring unit 2151. By employing such a configuration, optical intensity of the first signal light 31 output from the first multicore erbium-doped fiber 2110 can be controlled.

Likewise, the light amplification device 2000 can be configured in such a way as to further include a second monitoring unit 2251 and a second control unit 2252. Herein, the second monitoring unit 2251 monitors optical intensity of at least one of the second signal light 32 and the third residual excitation light 23 output from the second multicore erbium-doped fiber 2210. Then, the second control unit 2252 controls the optical attenuator 2243, which controls optical intensity of the first residual excitation light 21, based on a result of monitoring by the second monitoring unit 2251. By employing such a configuration, optical intensity of the second signal light 32 output from the second multicore erbium-doped fiber 2210 can be controlled.

Next, a light amplification method according to the present example embodiment is described.

In the light amplification method according to the present example embodiment, first, first signal light is introduced into a first optical waveguide including a first light amplification medium, and second signal light is introduced into a second optical waveguide including a second light amplification medium. Then, first excitation light, which excites the first light amplification medium, is introduced into the first optical waveguide, and first residual excitation light, which is output from the first optical waveguide and contains a wavelength component of the first excitation light, is introduced into the second optical waveguide. Further, the first residual excitation light may also be introduced into the first optical waveguide.

The configuration described so far is similar to the light amplification method according to the first example embodiment. The light amplification method according to the present example embodiment is configured in such a way as that third residual excitation light, which is output from the second optical waveguide and contains a wavelength component of the first residual excitation light, is introduced in to the first optical waveguide. In this case, the third residual excitation light may further be introduced into the second optical waveguide.

As described above, according to the light amplification device 2000 and the light amplification method of the present example embodiment, utilization efficiency of excitation light can be increased even when a light amplification device including a multicore optical fiber is used in the cladding excitation method.

Some or all of the above-described example embodiments may be described as the following supplementary notes, but are not limited thereto.

(Supplementary Note 1) A light amplification device including: a first optical waveguide means including a first light amplification medium; a second optical waveguide means including a second light amplification medium; a first excitation light introducing means for introducing first excitation light that excites the first light amplification medium, into the first optical waveguide means; and a first residual excitation light introducing means for introducing first residual excitation light that is output from the first optical waveguide means and contains a wavelength component of the first excitation light, into the second optical waveguide means.

(Supplementary Note 2) The light amplification device according to supplementary note 1, further including a second residual excitation light introducing means for introducing the first residual excitation light into the first optical waveguide means.

(Supplementary Note 3) The light amplification device according to supplementary note 1 or 2, further including: a second excitation light introducing means for introducing second excitation light that excites the second light amplification medium, into the second optical waveguide means; a third residual excitation light introducing means for introducing second residual excitation light that is output from the second optical waveguide means and contains a wavelength component of the second excitation light, into the first optical waveguide means.

(Supplementary Note 4) The light amplification device according to supplementary note 3, wherein the first excitation light introducing means and the third residual excitation light introducing means include a first excitation light multiplexing means for multiplexing the first excitation light and the second residual excitation light, and the second excitation light introducing means and the first residual excitation light introducing means include a second excitation light multiplexing means for multiplexing the second excitation light and the first residual excitation light.

(Supplementary Note 5) The light amplification device according to supplementary note 1 or 2, further including a fourth residual excitation light introducing means for introducing third residual excitation light that is output from the second optical waveguide means and contains a wavelength component of the first residual excitation light, into the first optical waveguide means.

(Supplementary Note 6) The light amplification device according to supplementary note 5, further including a fifth residual excitation light introducing means for introducing the third residual excitation light into the second optical waveguide means.

(Supplementary Note 7) The light amplification device according to any one of supplementary notes 1 to 6, further including: signal light separation means for separating a signal light into first signal light to be introduced into the first optical waveguide means and second signal light to be introduced into the second optical waveguide means; a signal light multiplexing means for multiplexing the first signal light being output from the first optical waveguide means and the second signal light being output from the second optical waveguide means.

(Supplementary Note 8) A light amplification method including: introducing first signal light into a first optical waveguide including a first light amplification medium; introducing second signal light into a second optical waveguide including a second light amplification medium; introducing first excitation light that excites the first light amplification medium, into the first optical waveguide; and introducing first residual excitation light that is output from the first optical waveguide and contains a wavelength component of the first excitation light, into the second optical waveguide.

(Supplementary Note 9) The light amplification method according to supplementary note 8, further including introducing the first residual excitation light into the first optical waveguide.

(Supplementary Note 10) The light amplification method according to supplementary note 8 or 9, further including: introducing second excitation light that excites the second light amplification medium, into the second optical waveguide; and introducing second residual excitation light that is output from the second optical waveguide and contains a wavelength component of the second excitation light, into the first optical waveguide.

(Supplementary Note 11) The light amplification device according to supplementary note 4, wherein at least either of the first excitation light multiplexing means and the second excitation light multiplexing means is a space coupling type multiplexing means including a space optical system.

(Supplementary Note 12) The light amplification device according to any one of supplementary notes 3, 4, and 11, wherein a wavelength of the first excitation light is different from a wavelength of the second excitation light.

(Supplementary Note 13) The light amplification device according to any one of supplementary notes 3, 4, 11, and 12, wherein the first excitation light introducing means includes a first excitation light generation means for generating the first excitation light and a first optical coupling means for coupling the first excitation light to the first optical waveguide means, and the first residual excitation light introducing means includes a first residual excitation light coupling means for coupling the first residual excitation light to the second optical waveguide means, and a first residual excitation light separation means for separating the first residual excitation light from first signal light being output from the first optical waveguide means.

(Supplementary Note 14) The light amplification device according to any one of supplementary notes 3, 4, 11, and 12, wherein the second excitation light introducing means includes a second excitation light generation means for generating the second excitation light and a second optical coupling means for coupling the second excitation light to the second optical waveguide means, and the third residual excitation light introducing means includes a second residual excitation light coupling means for coupling the second residual excitation light to the first optical waveguide means and a second residual excitation light separation means for separating the second residual excitation light from second signal light being output from the second optical waveguide means.

(Supplementary Note 15) The light amplification device according to supplementary note 13, further including: a first monitoring means for monitoring optical intensity of at least either of the first signal light and the first residual excitation light that are output from the first optical waveguide means; and a first control means for controlling, based on a result of monitoring by the first monitoring means, at least either of a first optical attenuation means for controlling optical intensity of the second residual excitation light and the first excitation light generation means.

(Supplementary Note 16) The light amplification device according to supplementary note 14, further including: a second monitoring means for monitoring optical intensity of at least either of the second signal light and the second residual excitation light that are output from the second optical waveguide means; and a second control means for controlling, based on a result of monitoring by the second monitoring means, either of a second optical attenuation means for controlling optical intensity of the first residual excitation light and the second excitation light generation means.

(Supplementary Note 17) The light amplification device according to any one of supplementary notes 1 to 7 and 11 to 16, wherein the first optical waveguide means has gain in a first wavelength band, and the second optical waveguide means has gain in a second wavelength band being different from the first wavelength band.

(Supplementary Note 18) The light amplification device according to any one of supplementary notes 1 to 7 and 11 to 17, wherein both the first light amplification medium and the second light amplification medium are constituted of a plurality of cores doped with a rare-earth ion, both the first optical waveguide means and the second optical waveguide means include a multicore optical fiber including a plurality of optical transmission paths constituted of the plurality of cores and a double-cladding structure, and the first excitation light introducing means introduces the first excitation light into the first optical waveguide means by using a cladding excitation method.

(Supplementary Note 19) The light amplification method according to supplementary note 8 or 9, further including introducing third residual excitation light that is output from the second optical waveguide and contains a wavelength component of the first residual excitation light, into the first optical waveguide.

(Supplementary Note 20) The light amplification method according to supplementary note 19, further including introducing the third residual excitation light into the second optical waveguide.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2021-030665, filed on Feb. 26, 2021, the disclosure of which is incorporated herein in its entirety by reference.

### Reference Signs List

100, 101, 200, 201, 1000, 2000 Light amplification device
111 First optical waveguide
112 Second optical waveguide
120 First excitation light introducing unit
131 First residual excitation light introducing unit
132 Second residual excitation light introducing unit
211, 1110, 2110 First multicore erbium-doped fiber
212, 1210, 2210 Second multicore erbium-doped fiber
221, 1121, 2121 First excitation light generation unit
222, 1122, 2122 First optical coupling unit
231, 1231, 2231 First residual excitation light coupling unit
232, 1130, 2130 First residual excitation light separation unit
233 Residual excitation light splitting unit
241, 1310, 2310 Signal light separation unit
242, 1320, 2320 Signal light multiplexing unit
1100, 2100 First amplification unit
1131 Second residual excitation light coupling unit
1140 First excitation light multiplexing unit
1141, 1241, 2142, 2242 Optical isolator
1142, 1242, 2143, 2243 Optical attenuator
1151, 2151 First monitoring unit
1152, 2152 First control unit
1200, 2200 Second amplification unit
1221 Second excitation light generation unit
1222 Second optical coupling unit
1232 Second residual excitation light separation unit
1240 Second excitation light multiplexing unit
1251, 2251 Second monitoring unit
1252, 2252 Second control unit
2141 Excitation light multiplexing unit
2232 Residual excitation light separation unit
2240 Optical coupler
2241 Residual excitation light multiplexing unit
11 First excitation light
12 Second excitation light
21 First residual excitation light
22 Second residual excitation light
23 Third residual excitation light
30 Signal light
31 First signal light
32 Second signal light

What is claimed is:

1. A light amplification device comprising:
a first optical waveguide including a first light amplification medium;
a second optical waveguide including a second light amplification medium;
a first excitation light introducing circuit configured to introduce first excitation light that excites the first light amplification medium, into the first optical waveguide; and
a first residual excitation light introducing circuit configured to introduce first residual excitation light that is output from the first optical waveguide and contains a wavelength component of the first excitation light, into the second optical waveguide.

2. The light amplification device according to claim 1, further comprising a second residual excitation light introducing circuit configured to introduce the first residual excitation light into the first optical waveguide.

3. The light amplification device according to claim 1, further comprising:
a second excitation light introducing circuit configured to introduce second excitation light that excites the second light amplification medium, into the second optical waveguide; and
a third residual excitation light introducing circuit configured to introduce second residual excitation light that is output from the second optical waveguide and contains a wavelength component of the second excitation light, into the first optical waveguide.

4. The light amplification device according to claim 3, wherein
the first excitation light introducing circuit and the third residual excitation light introducing circuit include a first excitation light multiplexing circuit configured to multiplex the first excitation light and the second residual excitation light, and
the second excitation light introducing circuit and the first residual excitation light introducing circuit include a second excitation light multiplexing circuit configured to multiplex the second excitation light and the first residual excitation light.

5. The light amplification device according to claim 1, further comprising fourth residual excitation light introducing circuit configured to introduce third residual excitation light that is output from the second optical waveguide and contains a wavelength component of the first residual excitation light, into the first optical waveguide.

6. The light amplification device according to claim 5, further comprising a fifth residual excitation light introducing circuit configured to introduce the third residual excitation light into the second optical waveguide.

7. The light amplification device according to claim 1, further comprising:
a signal light separation circuit configured to separate signal light into first signal light to be introduced into the first optical waveguide and second signal light to be introduced into the second optical waveguide; and
a signal light multiplexing circuit configured to multiplex the first signal light being output form the first optical waveguide and the second signal light being output from the second optical waveguide.

8. A light amplification method comprising:
introducing first signal light into a first optical waveguide including a first light amplification medium;
introducing second signal light into a second optical waveguide including a second light amplification medium;
introducing first excitation light that excites the first light amplification medium, into the first optical waveguide; and
introducing first residual excitation light that is output from the first optical waveguide and contains a wavelength component of the first excitation light, into the second optical waveguide.

9. The light amplification method according to claim 8, further including introducing the first residual excitation light into the first optical waveguide.

10. The light amplification method according to claim 8, further comprising:
introducing second excitation light that excites the second light amplification medium, into the second optical waveguide; and
introducing second residual excitation light that is output from the second optical waveguide and contains a wavelength component of the second excitation light, into the first optical waveguide.

11. The light amplification device according to claim 4, wherein
at least either of the first excitation light multiplexing circuit and the second excitation light multiplexing circuit is a space coupling type multiplexing circuit including a space optical system.

12. The light amplification device according to claim 3, wherein a wavelength of the first excitation light is different from a wavelength of the second excitation light.

13. The light amplification device according to claim 3, wherein
the first excitation light introducing circuit includes a first excitation light generation circuit configured to generate the first excitation light and a first optical coupling circuit configured to couple the first excitation light to the first optical waveguide, and
the first residual excitation light introducing circuit includes a first residual excitation light coupling circuit configured to couple the first residual excitation light to the second optical waveguide, and a first residual excitation light separation circuit configured to separate the first residual excitation light from first signal light being output from the first optical waveguide.

14. The light amplification device according to claim 3, wherein
the second excitation light introducing circuit includes a second excitation light generation circuit configured to generate the second excitation light and a second optical coupling circuit configured to couple the second excitation light to the second optical waveguide, and
the third residual excitation light introducing circuit includes a second residual excitation light coupling circuit configured to couple the second residual excitation light to the first optical waveguide and a second residual excitation light separation circuit configured to separate the second residual excitation light from second signal light being output from the second optical waveguide.

15. The light amplification device according to claim 13, further comprising:
a first monitoring circuit configured to monitor optical intensity of at least either of the first signal light and the first residual excitation light that are output from the first optical waveguide; and
a first control circuit configured to control, based on a result of monitoring by the first monitoring circuit, at least either of a first optical attenuation circuit configured to control optical intensity of the second residual excitation light and the first excitation light generation circuit.

16. The light amplification device according to claim 14, further comprising:
a second monitoring circuit configured to monitor optical intensity of at least either of the second signal light and the second residual excitation light that are output from the second optical waveguide; and
a second control circuit configured to control, based on a result of monitoring by the second monitoring circuit, at least either of a second optical attenuation circuit configured to control optical intensity of the first residual excitation light and the second excitation light generation circuit.

17. The light amplification device according to claim 1, wherein
the first optical waveguide has gain in a first wavelength band, and
the second optical waveguide has gain in a second wavelength band being different from the first wavelength band.

18. The light amplification device according to claim 1, wherein
both the first light amplification medium and the second light amplification medium are constituted of a plurality of cores doped with a rare-earth ion,
both the first optical waveguide and the second optical waveguide include a multicore optical fiber including a plurality of optical transmission paths constituted of the plurality of cores and a double-cladding structure, and
the first excitation light introducing circuit introduces the first excitation light into the first optical waveguide by using a cladding excitation method.

19. The light amplification method according to claim 8, further comprising introducing third residual excitation light that is output from the second optical waveguide and contains a wavelength component of the first residual excitation light, into the first optical waveguide.

20. The light amplification method according to claim 19, further comprising introducing the third residual excitation light into the second optical waveguide.
